(19) United States
(12) Patent Application Publication
(10) Pub. No.: US 2014/0192418 A1
(43) Pub. Date: Jul. 10, 2014

(54) Optical Element and Optical Mechanism

(71) Applicant: OLYMPUS CORPORATION, TOKYO (JP)

(72) Inventor: Toshiaki Suzuki, Tokyo (JP)

(73) Assignee: OLYMPUS CORPORATION, TOKYO (JP)

(21) Appl. No.: 14/208,409

(22) Filed: Mar. 13, 2014

Related U.S. Application Data
(63) Continuation of application No. PCT/JP2012/005659, filed on Sep. 6, 2012.

(30) Foreign Application Priority Data
Sep. 13, 2011 (JP) 2011-199716

(51) Int. Cl. G02B 27/14

(52) U.S. Cl. CPC G02B 27/142
USPC 359/629

(57) ABSTRACT

An optical element includes a waveguide, a polarizing beam splitter film, and a deflector. The waveguide propagates light incident at a predetermined angle while reflecting the light between first and second planes. The polarizing beam splitter film is adhered to the first plane of the waveguide. The polarizing beam splitter film separates light incident from the waveguide into transmitted light and reflected light. The deflector is joined to the waveguide with the polarizing beam splitter film therebetween. The deflector has a plurality of first reflecting surfaces. The first reflecting surfaces reflect, in a direction substantially perpendicular to a surface of the polarizing beam splitter film, light transmitted by the polarizing beam splitter film. The polarizing beam splitter film reflects the majority of light incident at a predetermined angle from the waveguide and transmits a majority or all of the light incident in a substantially perpendicular direction from the deflector.

### CROSS-REFERENCE TO RELATED APPLICATION

The present application is a Continuing application based on International Application PCT/JP2012/005689 filed on Sep. 6, 2012, which, in turn, claims the priority from Japanese Patent Application No. 2011-199716 filed on Sep. 13, 2011, the entire disclosure of which is incorporated herein by reference.

### TECHNICAL FIELD

The present invention relates to an optical element and optical mechanism with an expanded exit pupil.

### BACKGROUND ART

A variety of known display devices are projection-type displays that display a projected image. In order to observe the projected image, the observer's eye needs to be aligned with the exit pupil of the projection optical system. Therefore, in order for the projected image to be observable at a variety of positions, the exit pupil is preferably made large. In a conventional projection-type display, however, the structure of an optical system with an expanded exit pupil is large and complex. Therefore, there has been a desire for simplifying the structure of an optical system with an expanded exit pupil. It has thus been proposed to enlarge the exit pupil with an optical element that uses a volume hologram (see Non-patent Literature 1).

### CITATION LIST

### Non-Patent Literature

NPL 1: Alex CAMERON, “The Application of Holographic Optical Waveguide Technology to Q-Sight Family of Helmet Mounted Displays”, Proc. of SPIE Vol. 7326, April, 2009

### SUMMARY OF INVENTION

### Technical Problem

With reference to FIG. 15, the following describes the optical element disclosed in Non-patent Literature 1. FIG. 15 is a block diagram schematically illustrating the structure of a display device using an optical element. A display device 19′ includes an image projection unit 30′ and an optical element 10′.

The image projection unit 30′ includes a display element 31′ and a projection lens 32′. The image displayed by the display element 31′ is projected at a distance by the projection lens 32′. Note that the projected image can be observed by aligning the observer's eye with the exit pupil of the projection lens 32′. Since there is only one exit pupil of the projection lens 32′, however, the image displayed by the display element 31′ is only observable at one eye point.

The optical element 10′ is configured with first and second transparent media 33a′ and 33b′ and a volume hologram sheet 34′. The first and second transparent media 33a′ and 33b′ are in the form of a flat plate, and the volume hologram sheet 34′ is sandwiched between the first and second transparent media 33a′ and 33b′. The volume hologram sheet 34′ separates incident light into straight-traveling light and diffracted light. Note that in FIG. 15, the length direction of the first and second transparent media 33a′ and 33b′ is the x-direction, whereas the width direction is the y-direction.

A triangular prism 35′ is adhered to the surface of the optical element 10′ on the first transparent medium 33a′ side thereof. The image projection unit 30′ is arranged so that a light beam Lx projected from the image projection unit 30′ is obliquely incident on the optical element 10′ via the triangular prism 35′ and so that conditions described below are fulfilled.

The light beam Lx obliquely incident on the optical element 10′ propagates in the x-direction while being reflected between first and second surfaces 36a′ and 36b′, which are surfaces respectively on the first and second transparent media 33a′ and 33b′ sides of the optical element 10′. Note that the image projection unit 30′ is arranged so that the light beam Lx is totally reflected at the first and second surfaces 36a′ and 36b′.

As described above, the light beam Lx incident on the volume hologram sheet 34′ is separated into straight-traveling light and diffracted light. For example, light entering the volume hologram sheet 34′ from the first surface 36a′ side is separated into diffracted light diffracted in a direction perpendicular to the second surface 36b′ and straight-traveling light that is obliquely incident on the second transparent medium 33b′.

The diffracted light passes through the second surface 36b′ and exits the optical element 10′. The straight-traveling light is totally reflected at the second surface 36b′ and enters the first transparent medium 33a′ via the volume hologram sheet 34′. Thereafter, total reflection at the first and second surfaces 36a′ and 36b′ and separation at the volume hologram sheet 34′ are similarly repeated, so that the light beam Lx forming an image is emitted from a plurality of positions along the second surface 36b′. In other words, a plurality of copies of exit pupils are formed on the second surface 36b′ side.

By generating a plurality of copies of exit pupils, the image is observable at a plurality of eye points ep. By having the diameter of the exit pupil of the projection lens 32′ match the interval between the formation positions of the copies, the copies of the exit pupils come into uninterrupted contact, so that the image is observable from any eye point along the second surface 36b′. Accordingly, the exit pupil can be considered to have been expanded by the optical element 10′.

The light beam Lx, however, is also separated into diffracted light and straight-traveling light upon entering the volume hologram sheet 34′ from the second transparent medium 33b′. Therefore, a plurality of copies of exit pupils are also formed on the first surface 36a′ side. A structure allowing for observability from one surface of the optical element 10′ is sufficient, and emitting the light beam Lx from both surfaces reduces the use efficiency of light.

The present invention has been conceived in light of the above circumstances, and it is an object thereof to provide an optical element with improved use efficiency of light.

### Solution to Problem

In order to solve the above problems, an optical element according to the present invention includes a first waveguide, formed as a plate having a first plane and a second plane opposing each other, that propagates light incident at a predetermined angle while reflecting the light between the first plane and the second plane; a first beam splitter film, adhered to the first plane of the first waveguide, that separates light incident from the first waveguide into transmitted light and reflected light; and a first deflector, joined to the first waveguide with the first beam splitter film therebetween, that has a plurality of first reflecting surfaces provided along a first direction, the first reflecting surfaces reflecting, in a direction substantially perpendicular to a surface of the first beam splitter film, light that is incident on the first plane at the predetermined angle and transmitted by the first beam splitter film, the first beam splitter film reflecting a majority of light incident at the predetermined angle from the first waveguide and transmitting a majority or all of light incident in a substantially perpendicular direction from the first deflector.

In order to solve the above problems, an optical mechanism according to the present invention includes a first optical element that includes a first waveguide, formed as a plate having a first plane and a second plane opposing each other, that propagates light incident at a predetermined angle while reflecting the light between the first plane and the second plane; a first beam splitter film, adhered to the first plane of the first waveguide, that separates light incident from the first waveguide into transmitted light and reflected light; a first deflector, joined to the first waveguide with the first beam splitter film therebetween, having a plurality of first reflecting surfaces provided along a first direction, the first reflecting surfaces reflecting, in a direction substantially perpendicular to a surface of the first beam splitter film, light that is incident on the first plane at the predetermined angle and transmitted by the first beam splitter film; and a plurality of second reflecting surfaces reflecting light incident on the optical element towards the first waveguide so that light is incident on the second plane at an angle of at least a critical angle in the first waveguide, the first beam splitter film reflecting a majority of light incident at the predetermined angle from the first waveguide and transmitting a majority or all of light incident in a substantially perpendicular direction from the first deflector, and an angle between each of the first reflecting surfaces and the first plane being in a neighborhood of a half angle of the predetermined angle; and a second optical element that includes a second waveguide, formed as a plate having a third plane and a fourth plane opposing each other, propagating light incident at a second predetermined angle while reflecting the light between the third plane and the fourth plane; a second beam splitter film, adhered to the third plane of the second waveguide, separating light incident from the second waveguide into transmitted light and reflected light; and a second deflector, joined to the second waveguide with the second beam splitter film therebetween, having a plurality of third reflecting surfaces provided along a second direction differing from the first direction, the third reflecting surfaces reflecting, in a direction substantially perpendicular to a surface of the second beam splitter film, light that is incident on the third plane at the second predetermined angle and transmitted by the second beam splitter film, the second beam splitter film reflecting a majority of light incident at the second predetermined angle from the second waveguide and transmitting a majority or all of light incident in a substantially perpendicular direction from the second deflector, and the first optical element and the second optical element being disposed so that light emitted from the fourth plane of the second optical element is incident on the second reflecting surfaces.

### Advantageous Effect of Invention

With the above-described structure, the optical element according to the present invention expands the exit pupil while suppressing emission of light from the first reflecting surface side.

### BRIEF DESCRIPTION OF DRAWINGS

The present invention will be further described below with reference to the accompanying drawings, wherein:

FIG. 1 is a perspective view of an optical element according to Embodiment 1 of the present invention;

FIG. 2 is a side view of the optical element of Embodiment 1;

FIG. 3 is a graph illustrating the ratio of intensity of emitted light to incident light according to the number of reflections by a polarizing beam splitter film in the optical element of Embodiment 1;

FIG. 4 is a graph of reflectance versus thin film wavelength to illustrate the property by which the spectral curve of the thin film is shifted in the wavelength direction due to the angle of incidence;

FIG. 5 is a perspective view of an optical mechanism of Embodiment 1;

FIG. 6 is a perspective view of the internal structure of a display device using the optical mechanism of Embodiment 1;

FIG. 7 is a plan view of the internal structure of the display device using the optical mechanism of Embodiment 1;

FIG. 8 illustrates how a projected image is visible at any distance from the display device using the optical mechanism of Embodiment 1;

FIG. 9 is a side view of an optical element of Embodiment 2;

FIG. 10 is a side view of an optical element of Embodiment 3;

FIG. 11 is a perspective view of an optical mechanism of Embodiment 3;

FIG. 12 is a side view of the internal structure of a display device using the optical mechanism of Embodiment 3;

FIG. 13 is a side view of an optical element of Embodiment 4;

FIG. 14 is a graph of transmittance in accordance with distance from the incident area of the polarizing beam splitter film in an optical element of Embodiment 5; and

FIG. 15 is a block diagram conceptually illustrating the structure of a display device using an optical element having a conventional pupil enlarging function.

### DESCRIPTION OF EMBODIMENTS

The following describes embodiments of the present invention with reference to the drawings.

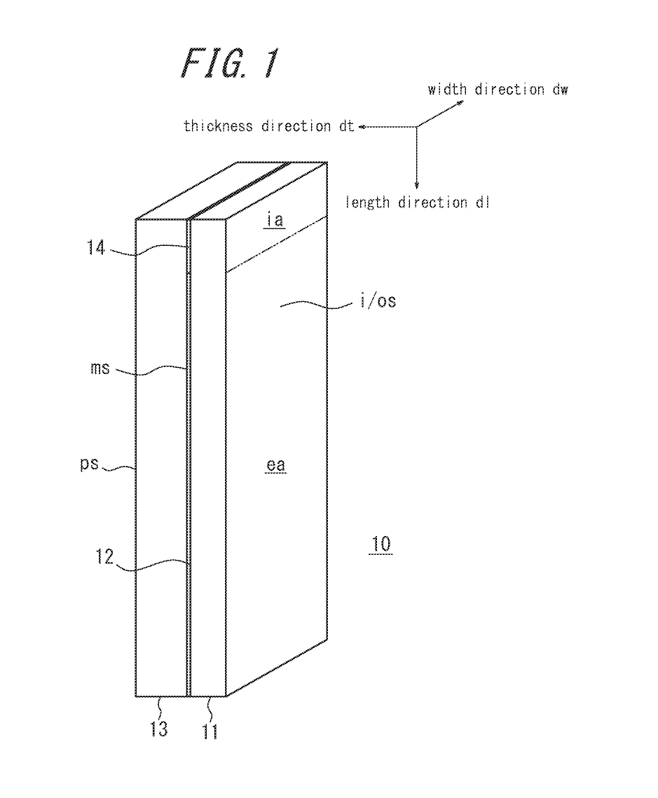

FIG. 1 is a perspective view of an optical element according to Embodiment 1 of the present invention.

As illustrated in FIG. 1, the optical element 10 includes a waveguide 11, a polarizing beam splitter film 12, and a deflector 13. The waveguide 11 is in plate form, and the polarizing beam splitter film 12 is formed on one side of the waveguide 11 by vapor deposition. The deflector 13 is in plate form, the plate surfaces thereof being a plane and a triangular prism array surface, at a back side of the deflector 13, on which a triangular prism array is formed (not illustrated in FIG. 1). The surface of the waveguide 11 on which the polarizing beam splitter film 12 is formed (first plane; referred to below as film formation surface ms) and the plane of the deflector 13 are joined by transparent adhesive (not illustrated), thus forming the optical element 10.

Note that the optical element 10 is overall in the form of a flat, rectangular plate having long sides and short sides. In a plane perpendicular to the thickness direction dt of the plate, the direction along the long sides is labeled the length direction dl, and the direction perpendicular to the thickness direction dt and the length direction dl is labeled the width direction dw.

The polarizing beam splitter film 12 is formed by vapor deposition to be a dielectric with a multi-layer film structure designed by a computer simulation so as to transmit light incident from a substantially perpendicular direction, to reflect the majority of obliquely incident light, and to transmit the remainder thereof. For example, the polarizing beam splitter film 12 can be formed to have such optical characteristics with respect to s-polarized light.

For the waveguide 11, quartz (transparent medium) having a thickness of 2 mm, for example, is used. Using quartz for the waveguide 11 is advantageous in that quartz has heat resistance with respect to heat during vapor deposition of the polarizing beam splitter film 12 and is also hard, thus not warping easily due to film stress. Another advantage is that since quartz is hard, the surface used as the total reflection surface at the back side of the film formation surface ms (second plane; referred to below as input/output port surface i/os) does not scratch easily.

For the deflector 13, acrylic having a thickness of 3 mm, for example, is used. The triangular prism array formed on the deflector 13 is minute and is formed by injection molding. Therefore, acrylic is selected as an example of an injection moldable transparent medium. Aluminum (reflecting member) is vapor deposited on a triangular prism array surface ps. Therefore, incident light is reflected at the triangular prism array surface ps.

An edge area along the length direction dl of the input/output port surface i/os is designated as an incident area ia. The area other than the incident area ia is designated as an emission area ea. In a predetermined area from the edge including the incident area ia, the polarizing beam splitter film 12 is not provided, but rather a hardened transparent adhesive 14 is interposed. Accordingly, in the area where the transparent adhesive 14 is interposed, light beams pass between the waveguide 11 and the deflector 13.

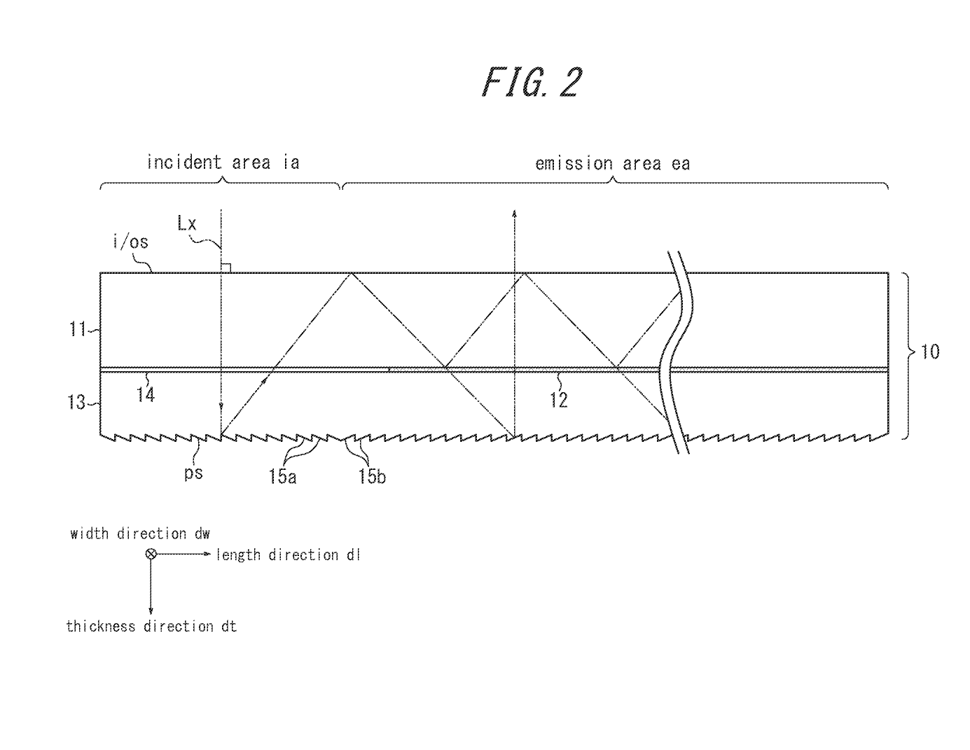

As illustrated in FIG. 2, the light beam Lx is incident on the incident area ia perpendicular to the input/output port surface i/os. The perpendicularly incident light beam Lx enters the deflector 13 from the waveguide 11 and is reflected obliquely by the triangular prism array surface ps. Note that the polarizing beam splitter film 12 is not provided in the reflection direction, and the obliquely reflected light beam Lx enters the waveguide 11 obliquely from the deflector 13.

The obliquely incident light beam Lx is totally reflected by the input/output port surface i/os so as to change direction towards the polarizing beam splitter film 12. At the interface, the majority of light is reflected. As described below, a portion of the light beam Lx is transmitted by the polarizing beam splitter film 12. Subsequently, the light beam Lx propagates in the length direction dl while total reflection at the input/output port surface i/os and reflection at the interface with the polarizing beam splitter film 12 are repeated.

If the refractive index of the waveguide 11 is higher than the refractive index of the deflector 13, then the angle of emergence is narrower when the light beam Lx is incident on the waveguide 11 from the deflector 13. If the angle of emergence narrows, the number of reflections increases for the unit propagation distance in the length direction dl. Since the number of reflections increases, propagation from the incident area ia to the opposite edge becomes difficult. Therefore, the refractive index of the waveguide 11 is preferably smaller than the refractive index of the deflector 13. Note that since the refractive index of quartz is 1.45 and the refractive index of acrylic is 1.49, the refractive index of the waveguide 11 is smaller than the refractive index of the deflector 13.

The polarizing beam splitter film 12 with the above-described qualities becomes easier to design as the refractive indices of the media on either side of the polarizing beam splitter film 12 are closer to each other. As described above, the refractive indices of quartz and acrylic are relatively close, making the polarizing beam splitter film 12 with the above-described characteristics easy to design.

A plurality of first and second triangular prisms 15a and 15b are formed on the triangular prism array surface ps along the width direction dw. The first triangular prisms 15a are formed below the incident area ia, and the second triangular prisms 15b are formed below the emission area ea. The first and second triangular prisms 15a and 15b each have an inclined surface, defined by inclining a plane perpendicular to the thickness direction dt about a line parallel to the width direction dw, and a perpendicular surface perpendicular to the length direction dl.

The inclined surfaces of the first triangular prism 15a and the second triangular prism 15b are inclined in opposite directions, and the absolute values of the inclination angles are equivalent. A normal line from the inclined surface of the first triangular prism 15a (second reflecting surface) extends towards the emission area ea side of the waveguide 11. Accordingly, as described above, the light beam Lx perpendicularly incident on the incident area ia from the input/output port surface i/os is reflected by the first triangular prism 15a towards the emission area ea. On the other hand, a normal line from the inclined surface of the second triangular prism 15b (first reflecting surface) extends towards the incident area ia side of the waveguide 11. Accordingly, as described in detail below, the light beam Lx that passes obliquely through the polarizing beam splitter film 12 is reflected perpendicularly towards the input/output port surface i/os.

The angle of the inclined surface is determined based on the critical angle at the input/output port surface i/os of the waveguide 11. In order to achieve the effects of the present embodiment, within the waveguide 11, the obliquely incident light beam Lx is required to propagate in the length direction dl while total reflection at the input/output port surface i/os and reflection at the polarizing beam splitter film 12 are repeated. Therefore, the light beam Lx needs to be caused to enter the waveguide 11 so that total reflection occurs at the input/output port surface i/os.

Since the angle of incidence θ with respect to the input/output port surface i/os (predetermined angle) needs to be larger than the critical angle, the inequality θ>sin⁻¹(1/n) needs to be satisfied. As described above, the refractive index of quartz, which is the material for the waveguide 11 in the present embodiment, is 1.45. Therefore, it is necessary to satisfy the inequality θ>sin⁻¹(1/1.45)=43.6°.

Since the angle of incidence θ is double the angle of the inclined surface of the first triangular prism 15a, the angle of the inclined surface needs to be at least 21.8°, i.e. the half angle of the angle of incidence θ (43.6°/2). Note that the materials of the waveguide 11 and the deflector 13 differ, yet as described above, the refractive index of the deflector 13 is larger than the refractive index of the waveguide 11, and therefore by forming the angle of the inclined surface in the deflector 13 to be 21.8° or more, total reflection of the light beam Lx can be achieved at the input/output port surface i/os.

On the other hand, as the inclination angle of the inclined surface increases, more light is lost from the light beam Lx due to vignetting because of the perpendicular surface of the adjacent first triangular prism 15a. Therefore, the inclination angle of the inclined surface is preferably near the lower limit. Hence, in the present embodiment, the inclination angle of the inclined surface is, for example, set to 25°.

When the inclination angle of the inclined surface is set to 25°, the light beam Lx perpendicularly incident on the input/output port surface i/os in the incident area is reflected by the inclined surface and enters the input/output port surface i/os in the emission area ea at an angle of incidence of 51.6°. Accordingly, since the angle of incidence in the input/output port surface i/os is larger than the critical angle, the light beam Lx can be totally reflected at the input/output port surface i/os. Centering on this angle, the angle of incidence of light that is obliquely incident on the input/output port surface i/os is allowed to fluctuate over a range that does not fall below the critical angle and thus has a tolerance of −8°.

The first and second triangular prisms 15a and 15b are aligned along the length direction dl. Accordingly, as seen from the width direction dw, the first and second triangular prisms 15a and 15b are aligned in sawtooth form. The pitch of the first and second triangular prisms 15a and 15b is, for example, 0.9 mm.

As the pitch of the first and second triangular prisms 15a and 15b is larger, more light is lost from the light beam Lx due to vignetting because of the perpendicular surface of the adjacent first and second triangular prisms 15a and 15b. Conversely, if the pitch is excessively small, the reflected light does not reflect regularly due to the effect of diffraction. Therefore, the pitch is preferably 0.3 mm or more. In the present embodiment, it is assumed that the width of the incident light beam Lx is from 5 mm to 10 mm. Accordingly, the above pitch of 0.9 mm is appropriate.

As described above, the polarizing beam splitter film 12 is designed to transmit light incident from a substantially perpendicular direction, reflect the majority of obliquely incident light, and transmit the remainder thereof. For example, the polarizing beam splitter film 12 is designed to have a reflectance of 95% and a transmittance of 5% with respect to obliquely incident light. Furthermore, the polarizing beam splitter film 12 is designed to have a transmittance of substantially 100%, for example, with respect to substantially perpendicular incident light. An angle that is within 5°, for example, of the perpendicular direction may be considered “substantially perpendicular”. At 5° or less, no clear difference occurs between p-polarized light and s-polarized light. If the angle of incidence is 5° or less, the reflectance and transmittance of the polarizing beam splitter film 12 are substantially the same as the reflectance and transmittance for an angle of incidence of 0°. Therefore, an angle of 5° or less is equivalent to the perpendicular direction.

Based on the above observations, the tolerance for the angle of view of the light beam Lx incident on the optical element 10 can be set from 7° to 8°.

The light beam Lx perpendicularly incident on the incident area is of the input/output port surface i/os in the optical element 10 with the above structure is reflected by the first triangular prisms 15a and then enters the emission area ea of the waveguide 11 obliquely. The obliquely incident light beam Lx strikes the input/output port surface i/os at an angle exceeding the critical angle and is totally reflected. The totally reflected light beam Lx then strikes the polarizing beam splitter film 12 obliquely, with 95% of the light beam Lx being reflected and 5% transmitted. The light beam Lx reflected by the polarizing beam splitter film 12 again strikes the input/output port surface i/os at an angle exceeding the critical angle and is totally reflected.

Subsequently, the light beam Lx propagates in the length direction dl of the waveguide 11 while partial reflection at the polarizing beam splitter film 12 and total reflection at the input/output port surface i/os are repeated. Upon reflection at the polarizing beam splitter film 12, however, 5% of the light beam Lx is transmitted, being emitted into the deflector 13.

The angle of emergence of the light beam Lx emitted into the deflector 13 is equivalent to the angle of incidence, at the interface with the waveguide 11, of the light beam Lx reflected by the first triangular prisms 15a. Therefore, the light beam Lx emitted into the deflector 13 is reflected by the second triangular prisms 15b in a direction perpendicular to the input/output port surface i/os. The perpendicularly reflected light beam Lx passes through the polarizing beam splitter film 12 with a transmittance of substantially 100% and is emitted from the input/output port surface i/os.

The length of the waveguide 11 in the length direction dl is, for example, 100 mm, and the light beam Lx obliquely incident on the emission area ea from the incident area is reflected approximately 20 times between the input/output port surface i/os and the polarizing beam splitter film 12 before reaching the edge of the emission area ea. At each reflection, the light path branches at the polarizing beam splitter film 12, and as described above, light is emitted from the input/output port surface i/os. Therefore, for a length of 100 mm, an array of approximately 20 branches of light is formed. Accordingly, in order to emit the branches of light from the input/output port surface i/os without gaps, it is necessary for the incident light beam Lx to have a diameter of 5 mm (100/20 mm) or more.

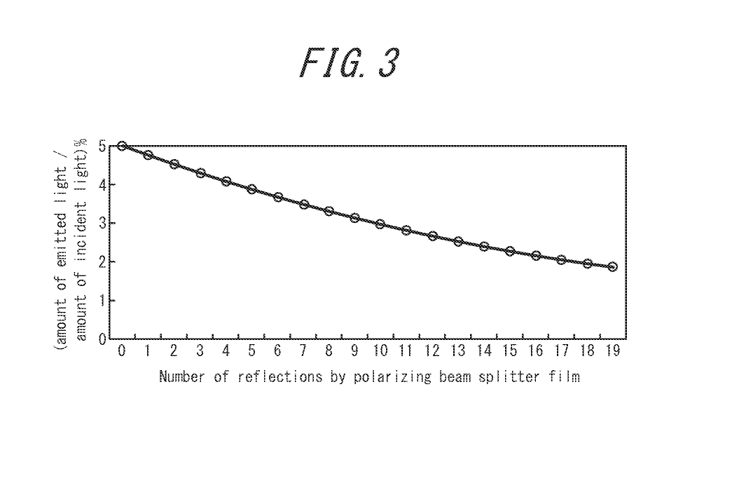

As described above, each time the light beam Lx that propagates in the waveguide 11 is reflected by the polarizing beam splitter film 12, a portion of the light is emitted as a branch of light, and therefore the intensity of the emitted light decreases as a geometric progression in accordance with the number of reflections (see FIG. 3). Hence, if the transmittance of the polarizing beam splitter film 12 with respect to obliquely incident light is increased, it becomes difficult to propagate the incident light beam Lx to the end of the waveguide 11.

In the present embodiment, the setting for the transmittance that the polarizing beam splitter film 12 should have with respect to obliquely incident light is simplified as 100%/(number of reflections). Using the above-described number of reflections yields a transmittance of 5%. Furthermore, calculating reflectance as 100%−(transmittance %) yields a reflectance of 95%.

Using the transmittance and reflectance set as described above, the intensity ratio between the light beam Lx that is emitted first to the light beam Lx that is emitted last from the input/output port surface i/os is approximately 2.5. The brightness is thus clearly uneven. In order to reduce the unevenness in the brightness, it suffices to set the transmittance lower. For example, setting the transmittance to 3% and the reflectance to 97% improves the intensity ratio of the light beam Lx that is emitted first to the light beam Lx that is emitted last from the input/output port surface i/os to approximately 1.8.

By setting the transmittance to be small, however, the amount of light that reaches the edge of the emission area ea without being emitted increases, thus increasing the energy loss of the incident light beam Lx. In other words, the use efficiency of light lowers. With the transmittance set to 5% and the reflectance to 95% in the present embodiment, the total amount of the light beam Lx that is emitted from the input/output port surface i/os is 64% of the incident light beam Lx. On the other hand, with the transmittance set to 3% and the reflectance to 97% in the above example for comparison, the total amount of the light beam Lx that is emitted from the input/output port surface i/os is 46% of the incident light beam Lx.

In this way, attempting to reduce the unevenness in the brightness also reduces the use efficiency of light. Therefore, the transmittance is preferably set so as to optimize the unevenness in the brightness and the use efficiency of light. Since the sensitivity of visual perception is logarithmic, an unevenness in the brightness of approximately a factor of 2.5 is not easily perceived when using the optical element 10 in a display device described below (not illustrated in FIGS. 1 to 3). Furthermore, considering the variation in characteristics at the time of vapor deposition, it is difficult to form the polarizing beam splitter film 12 to have a transmittance of less than 5%, for example. Therefore, the setting for transmittance in the present embodiment allows for actual formation and maintains a high use efficiency of light while keeping the unevenness in the brightness low enough for intended use.

As described above, the polarizing beam splitter film 12 has characteristics of a reflectance of 95% and a transmittance of 5% for s-polarized obliquely incident light and characteristics of a transmittance of substantially 100% for substantially perpendicular incident light. A thin film having low-pass or band-pass spectral reflectance characteristics can have such conflicting characteristics.

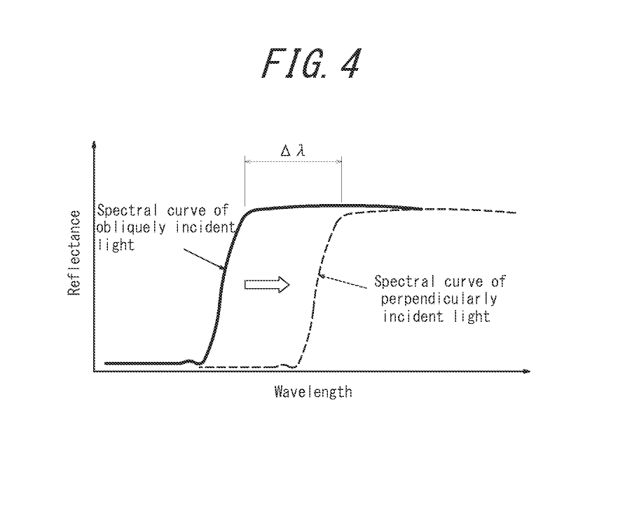

As is known, in a thin film the spectral curve is shifted in the wavelength direction in accordance with the angle of incidence. As illustrated in FIG. 4, the spectral curve for substantially perpendicular incident light (dashed line) is shifted in the direction of a longer wavelength from the spectral curve for obliquely incident light (solid line). By a combination of the wavelength of the incident light beam Lx being between the cutoff wavelengths for both the spectral curve for obliquely incident light and the spectral curve for substantially perpendicular incident light, and the thin film being set to have a reflectance of 95% for obliquely incident light and a reflectance of 0% for substantially perpendicular incident light, it is possible to form the polarizing beam splitter film 12 of the present embodiment.

The shift amount Δλ of the spectral curve is calculated as Δλ=(1−cos θ′)×λ₀, where θ′ is the angle of refraction upon entering the thin film, and λ₀ is the wavelength of incident light. Estimating the angle of refraction of the light beam Lx incident on the polarizing beam splitter film 12 in the present embodiment to be 51.6°, a large shift amount of Δλ=240 nm can be obtained by incident monochromatic light with a wavelength of λ₀=635 nm. Accordingly, for an s-polarized light beam Lx with a wavelength of λ₀=635 nm, it is actually possible to form the polarizing beam splitter film 12 to reflect the majority of obliquely incident light and to transmit almost all substantially perpendicular incident light.

In the optical element 10 with the above-described structure, approximately 20 light beams Lx are emitted per 100 mm. Therefore, by causing a light beam Lx with a width of 5 mm or more to strike the incident area is of the input/output port surface i/os, adjacent emitted light beams Lx come into contact with each other, so that a light beam with a total width of 100 mm is emitted. In other words, the light beam is extended from a width of 5 mm to 100 mm, so that the optical element 10 functions as a pupil enlarging optical element, like a conventional technique.

According to the optical element 10 of Embodiment 1 with the above structure, the incident light beam Lx is expanded and emitted from only the input/output port surface i/os, which is one plate surface of a flat plate. Therefore, while having a function to enlarge the pupil, the optical element 10 offers improved use efficiency of light as compared to an optical element using a conventional volume hologram sheet that expands and emits a light beam from both surfaces. Since the use efficiency of light is improved, the amount of light emitted from the light source (not illustrated in FIGS. 1 to 4) can be reduced as compared to conventional techniques, thereby allowing for a reduction in power consumption.

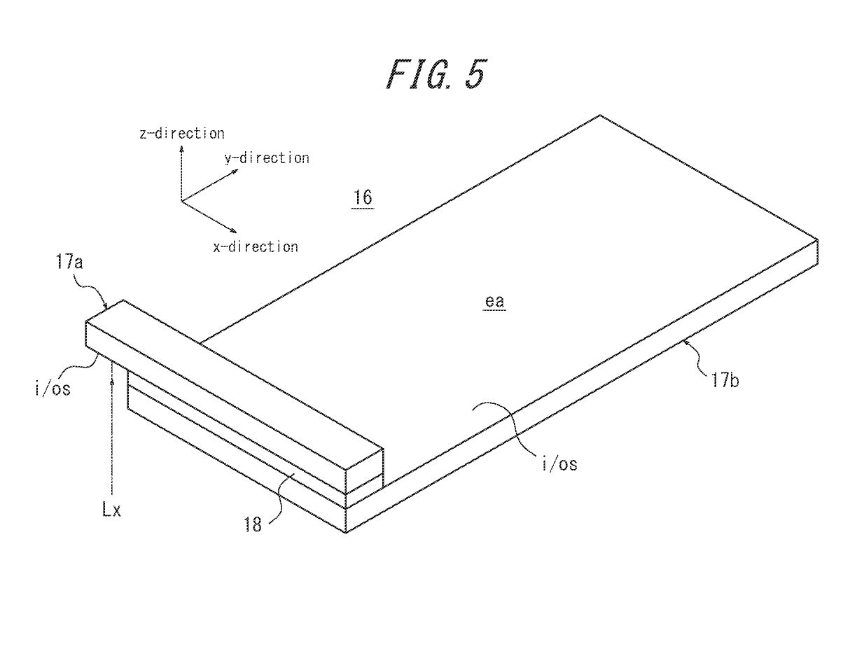

Next, using the optical element 10 of Embodiment 1, an optical mechanism of Embodiment 1 that enlarges the pupil in two dimensions is described. As illustrated in FIG. 5, an optical mechanism 16 is configured with first and second pupil enlarging plates 17a and 17b and a λ/2 wavelength plate 18. The first pupil enlarging plate 17a is the above-described optical element 10 with a modified size and modified settings for the polarizing beam splitter film 12, as described below. The second pupil enlarging plate 17b is the same as the above-described optical element 10.

The first pupil enlarging plate 17a is formed to have a width (length in the width direction dw) of 10 mm and an emission area ea (not illustrated in FIG. 5) with a length (length in the length direction dl) of 50 mm. The second pupil enlarging plate 17b is formed to have a width (length in the width direction dw) of 50 mm and an incident area ia (not illustrated in FIG. 5) and emission area ea with respective lengths (lengths in the length direction d1) of 10 mm and 100 mm.

The λ/2 wavelength plate 18 is sandwiched between the first and second pupil enlarging plates 17a and 17b. The first and second pupil enlarging plates 17a and 17b are overlaid so that a long side (a side in the length direction) of the first pupil enlarging plate 17a and a short side (a side in the width direction) of the second pupil enlarging plate 17b overlap, so that the emission area ea of the input/output port surface i/os in the first pupil enlarging plate 17a and the incident area ia of the input/output port surface i/os in the second pupil enlarging plate 17b face each other, and so that the incident area ia of the first pupil enlarging plate 17a projects from the second pupil enlarging plate 17b.

Note that in FIG. 5, the direction parallel to the length direction of the first pupil enlarging plate 17a and the width direction of the second pupil enlarging plate 17b is the x-direction, the direction parallel to the width direction of the first pupil enlarging plate 17a and the length direction of the second pupil enlarging plate 17b is the y-direction, and the direction parallel to the thickness direction of the first and second pupil enlarging plates 17a and 17b is the z-direction.

A space is provided between the first pupil enlarging plate 17a and the λ/2 wavelength plate 18. In the first pupil enlarging plate 17a, the input/output port surface i/os of the emission area ea that totally reflects light faces the λ/2 wavelength plate 18. Therefore, if the input/output port surface i/os and the λ/2 wavelength plate 18 are joined, light may be transmitted at the input/output port surface i/os in the first pupil enlarging plate 17a without being totally reflected. Hence, by providing a space, total reflection at the input/output port surface i/os of the light propagating through the first pupil enlarging plate 17a is guaranteed.

The polarizing beam splitter film 12 of the first pupil enlarging plate 17a is designed and formed so that the reflectance and transmittance of obliquely incident light are respectively 90% and 10%. The length in the propagation direction of an incident light beam due to the first pupil enlarging plate 17a is 50 mm, which is half the length (100 mm) of the above-described optical element 10. Therefore, the number of reflections in the polarizing beam splitter film 12 before reaching the edge of the emission area ea of the first pupil enlarging plate 17a is approximately half the number of reflections in the optical element 10. Hence, by setting the transmittance of the polarizing beam splitter film 12 in the first pupil enlarging plate 17a to be twice that of the optical element 10, unevenness in the brightness and use efficiency of light are optimized.

Upon causing the light beam Lx to enter the incident area ia of the first pupil enlarging plate 17a in the above-described optical mechanism 16 perpendicularly, the pupil is expanded in the x-direction, and the light beam Lx is emitted from the emission area ea of the first pupil enlarging plate 17a.

For the light beam emitted from the first pupil enlarging plate 17a, the polarization plane of the light beam Lx is rotated 90° by the λ/2 wavelength plate 18. By rotating the polarization plane 90°, the light beam Lx can be caused to enter the polarizing beam splitter film 12 of the second pupil enlarging plate 17b as s-polarized light.

The light beam with a rotated polarization plane then strikes the incident area ia of the second pupil enlarging plate 17b perpendicularly. The pupil of the light beam incident on the second pupil enlarging plate 17b is enlarged in the y-direction, and the light beam is emitted from the emission area ea of the second pupil enlarging plate 17b.

Accordingly, by causing a 5 mm by 5 mm light beam to strike the incident area ia of the first pupil enlarging plate 17a, projection light that is enlarged to have a pupil of 50 mm in the x-direction and 100 mm in the y-direction is emitted from the emission area ea of the second pupil enlarging plate 17b.

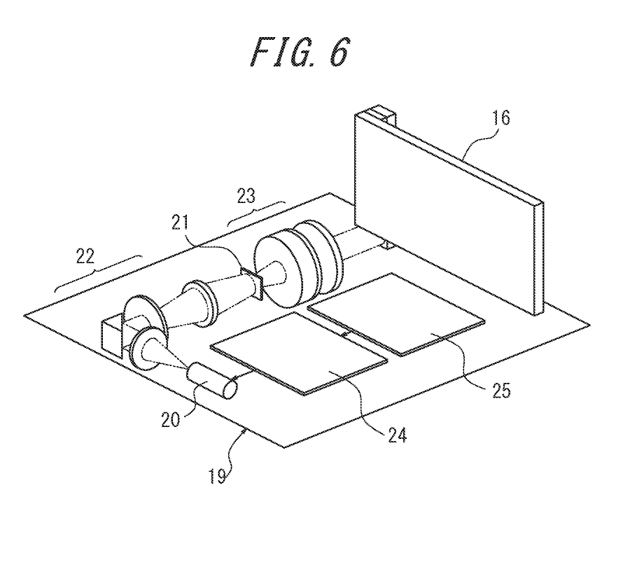

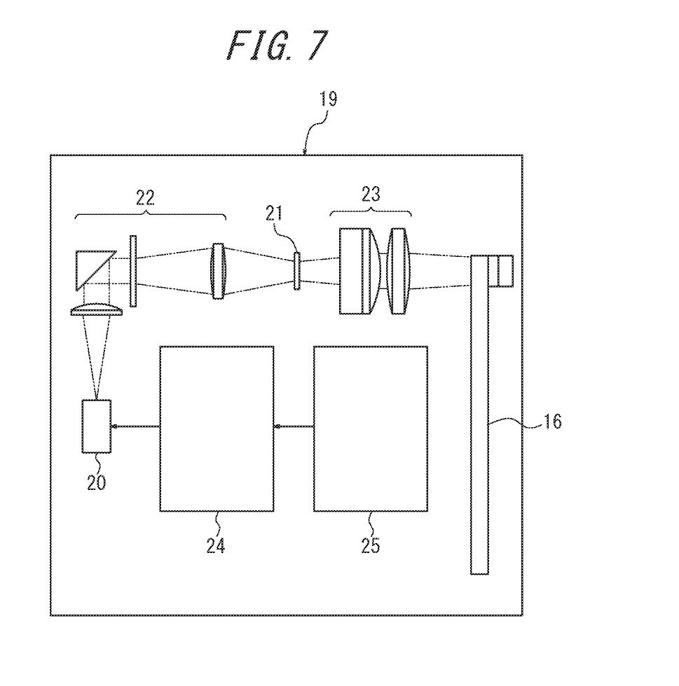

Next, with reference to FIGS. 6 and 7, a display device using the above-described optical mechanism 16 is described. FIG. 6 is a perspective view of the optical arrangement of components in the display device. FIG. 7 is a plan view of the optical arrangement of components in the display device.

A display device 19 includes a light source 20, a transmissive chart 21, and the optical mechanism 16. Illumination light is emitted from the light source 20 and illuminates the transmissive chart 21. The projection light from the illuminated transmissive chart 21 strikes the optical mechanism 16. The incident projection light is emitted with the pupil being enlarged by the optical mechanism 16. Note that instead of the transmissive chart 21, a structure may be adopted whereby an image for display is formed using a liquid crystal display element and projected onto the optical mechanism 16.

An illumination optical system 22 is arranged between the light source 20 and the transmissive chart 21, and a projection optical system 23 is arranged between the transmissive chart 21 and the optical mechanism 16. The light source 20, illumination optical system 22, transmissive chart 21, projection optical system 23, and optical mechanism 16 are optically attached.

As illumination light, a laser with a wavelength of 635 nm is emitted from the light source 20. The light source 20 is driven by a light source driver 24. Power for driving the light source is provided by a battery 25.

The illumination light is irradiated onto the transmissive chart 21 via the illumination optical system 22. The transmissive chart 21 has a size of 5.6 mm by 4.5 mm, for example. The projection light of the transmissive chart 21 is projected onto the first pupil enlarging plate 17a and the incident area ia of the optical mechanism 16 by the projection optical system 23. Note that the exit pupil of the projection optical system 23 and the incident area ia of the first pupil enlarging plate 17a in the optical mechanism 16 are aligned.

The projection optical system 23 has a focal length of 28 mm, for example, and can project projection light towards infinity. The projection angle of view of projection light is ±5.7° in the horizontal direction and ±4.6° in the vertical direction. This angle of view is within the tolerance for the angle of incidence of the optical element 10 used in the optical mechanism 16 of the present embodiment. Via the projection optical system 23, the projection light from the transmissive chart 21 strikes the optical mechanism 16 with a 10 mm diameter pupil.

When not using the optical mechanism 16, the image of the chart is observable by aligning the observer's eye to the exit pupil of the projection optical system 23. It is uncomfortable, however, for the observer to align the eye continuously to a 10 mm diameter exit pupil. By contrast, with the display device 19 of the present embodiment, the size of the pupil is expanded to 100 mm by 50 mm by the optical mechanism 16, so that the observer can easily align the eye to the enlarged exit pupil.

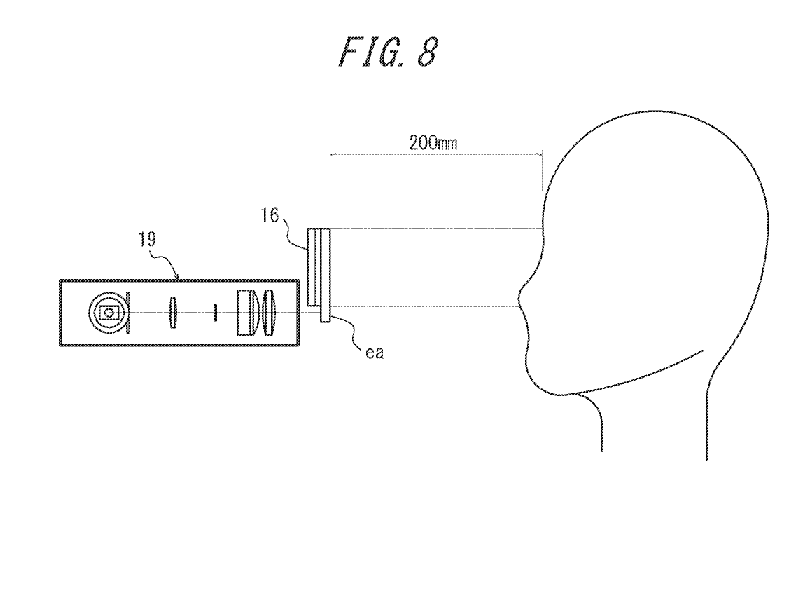

For example, as illustrated in FIG. 8, the image is observable at a position 200 mm away from the emission area ea of the optical mechanism 16 in the display device 19. Furthermore, a 50 mm wide by 40 mm high chart image can be seen at any distance. Note that since an image is formed at an infinite distance with the display device 19, farsighted and presbyopic observers can also view the projected image.

Next, an optical element and optical mechanism according to Embodiment 2 of the present invention are described. Embodiment 2 differs from Embodiment 1 in that the input/output port surface of the optical element is covered by a polarizing highly reflective film and a cover glass, and in that the structure of the optical mechanism differs. Embodiment 2 is described below focusing on the differences from Embodiment 1. Note that components with the same function and structure as in Embodiment 1 are labeled with the same reference signs.

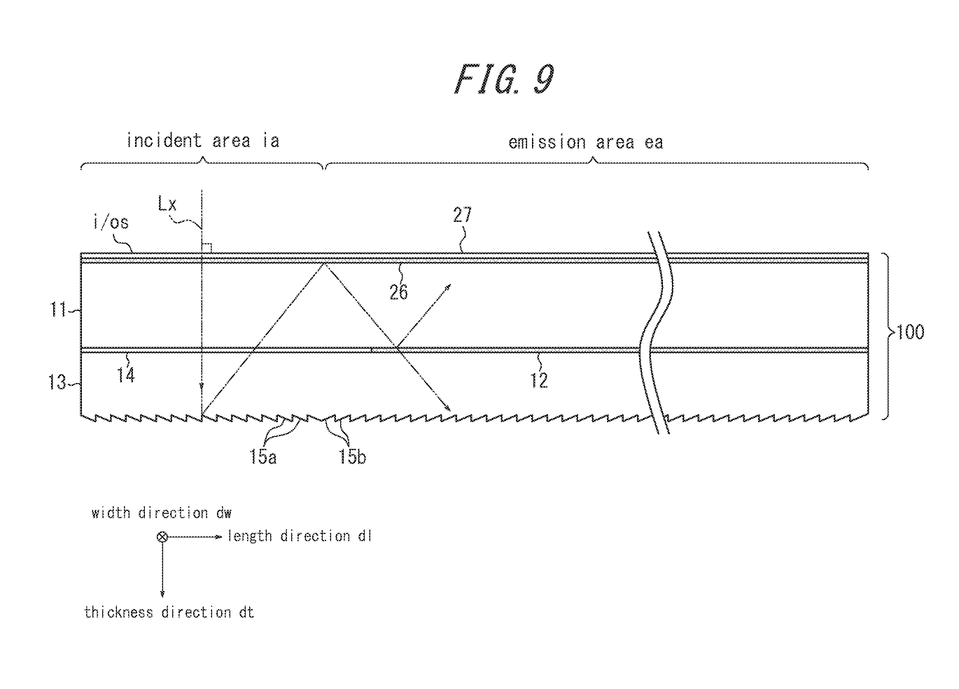

As illustrated in FIG. 9, an optical element 100 of Embodiment 2 includes a waveguide 11, a polarizing beam splitter film 12, a deflector 13, a polarizing highly reflective film 26 (oblique light reflective film), and a cover glass 27 (cover). The waveguide 11, polarizing beam splitter film 12, and deflector 13 have the same structure and function as in Embodiment 1.

The polarizing highly reflective film 26 is vapor deposited on the entire surface of the input/output port surface i/os in the waveguide 11. The polarizing highly reflective film 26 is designed by a computer simulation to be a dielectric with a multi-layer film structure that transmits light incident from a substantially perpendicular direction and reflects obliquely incident light at a reflectance of substantially 100%. The entire surface of the polarizing highly reflective film 26 is covered by the cover glass 27.

As in Embodiment 1, the light beam Lx perpendicularly incident on the incident area is at the input/output port surface i/os side is reflected by the first triangular prisms 15a and then enters the emission area ea of the waveguide 11 obliquely. Unlike Embodiment 1, however, the obliquely incident light beam Lx strikes the polarizing highly reflective film 26 obliquely and is reflected.

Subsequently, as in Embodiment 1, the light beam Lx propagates in the length direction dl while transmission of a portion and reflection of the majority of light by the polarizing beam splitter film 12 and reflection by the polarizing highly reflective film 26 are repeated.

The light beam Lx passing through the polarizing beam splitter film 12 is reflected by the second triangular prisms 15b in a direction perpendicular to the input/output port surface i/os. Accordingly, the reflected light beam Lx passes through the polarizing beam splitter film 12, polarizing highly reflective film 26, and cover glass 27 to be emitted from the input/output port surface i/os.

Therefore, like the optical element 10 of Embodiment 1, the optical element 100 of Embodiment 2 has the function of expanding the pupil of a light beam incident on the incident area ia.

According as well to the optical element of Embodiment 2 with the above structure, the incident light beam is expanded and emitted from only one plate surface of a flat plate. Therefore, while having a function to enlarge the pupil, the optical element offers improved use efficiency of light.

Furthermore, according to the optical element 100 of Embodiment 2, the surface is covered by the cover glass 27, thereby preventing the polarizing highly reflective film 26 and input/output port surface i/os from becoming damaged or dirty, which would impair the reflective function. Accordingly, the function of propagating light beams can be maintained.

Next, using the optical element 100 of Embodiment 2, an optical mechanism of Embodiment 2 that enlarges the pupil in two dimensions is described. Like the optical mechanism of Embodiment 1, the optical mechanism of Embodiment 2 is configured with first and second pupil enlarging plates 17a and 17b (first and second optical elements) and a λ/2 wavelength plate 18. Unlike Embodiment 1, the first and second pupil enlarging plates 17a and 17b are each the optical element 100 of Embodiment 2.

In Embodiment 2, unlike Embodiment 1, the first pupil enlarging plate 17a and the λ/2 wavelength plate 18 are fixedly adhered together without provision of a space therebetween. Since light beams are reflected at the interface along the inside of the cover glass 27 in the optical element 100 of Embodiment 2, obliquely incident light is not transmitted even if no space is provided. Therefore, by adhering the first pupil enlarging plate 17a to the λ/2 wavelength plate 18, the mechanical strength can be increased.

Next, an optical element and optical mechanism according to Embodiment 3 of the present invention are described. In Embodiment 3, the triangular prism array in the incident area ia is formed in a different portion than in Embodiment 1. Embodiment 3 is described below focusing on the differences from Embodiment 1. Note that components with the same function and structure as in Embodiment 1 are labeled with the same reference signs.

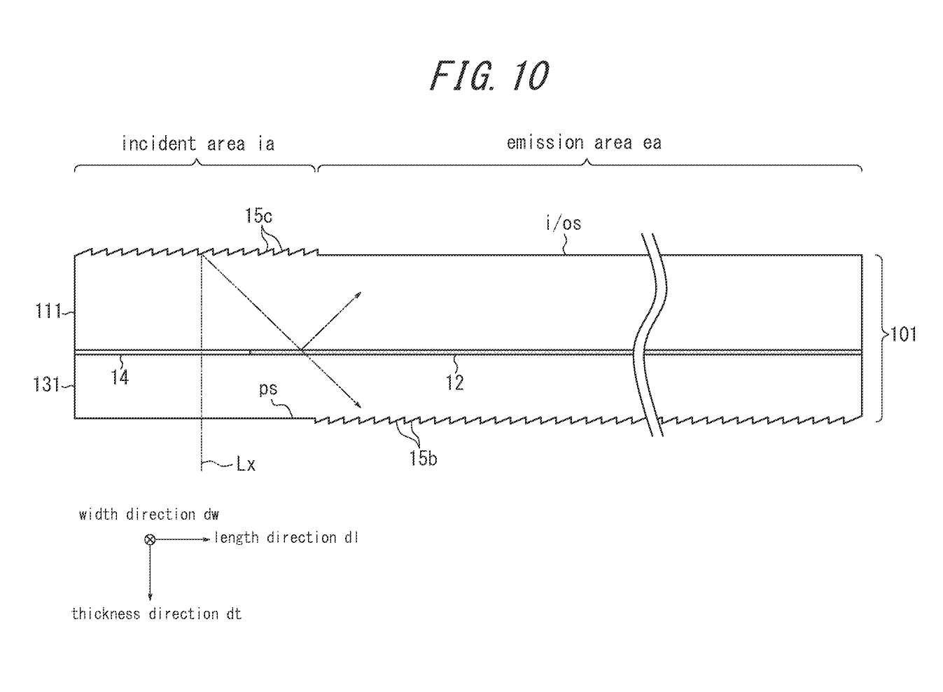

As illustrated in FIG. 10, an optical element 101 of Embodiment 3 includes a waveguide 111, a polarizing beam splitter film 12, and a deflector 131. As in Embodiment 1, a plurality of second triangular prisms 15b are formed on a triangular prism array surface ps of the deflector 131 below an emission area ea. The shape of each second triangular prism 15b is the same as in Embodiment 1. Also as in Embodiment 1, the emission area ea of an input/output port surface i/os in the waveguide 111 is planar.

Conversely, unlike Embodiment 1, the triangular prism array surface ps below the incident area ia is planar. Also unlike Embodiment 1, a plurality of third triangular prisms 15c is formed in the incident area ia of the input/output port surface i/os.

Like the first triangular prisms 15a, the third triangular prisms 15c are shaped to have an inclined surface and a perpendicular surface. The inclination angle of the inclined surface with respect to a plane parallel to the width direction dw and the length direction dl is 25°, like the first triangular prisms 15a.

A light beam Lx perpendicularly incident on the triangular prism array surface ps below the incident area ia of the optical element 101 with the above-described structure is reflected by the third triangular prisms 15c and guided to the polarizing beam splitter film 12. The reflected light beam Lx then strikes the polarizing beam splitter film 12 obliquely, with 95% of the light beam Lx being reflected and 5% transmitted.

Subsequently, as in Embodiment 1, the light beam Lx propagates in the length direction dl of the waveguide 111 while partial reflection at the polarizing beam splitter film 12 and total reflection at the input/output port surface i/os are repeated. Furthermore, like Embodiment 1, upon reflection at the polarizing beam splitter film 12, 5% of the light beam Lx is transmitted, being emitted into the deflector 131.

According as well to the optical element 101 of Embodiment 3 with the above structure, the incident light beam Lx is expanded and emitted from only one plate surface of a flat plate. Therefore, while having a function to enlarge the pupil, the optical element 101 offers improved use efficiency of light.

Next, using the optical element 101 of Embodiment 3, an optical mechanism of Embodiment 3 that enlarges the pupil in two dimensions is described. Like the optical mechanism of Embodiment 1, the optical mechanism of Embodiment 3 is configured with first and second pupil enlarging plates 171a and 171b and a λ/2 wavelength plate 18. Unlike Embodiment 1, the first and second pupil enlarging plates 171a and 171b are each the optical element 101 of Embodiment 3.

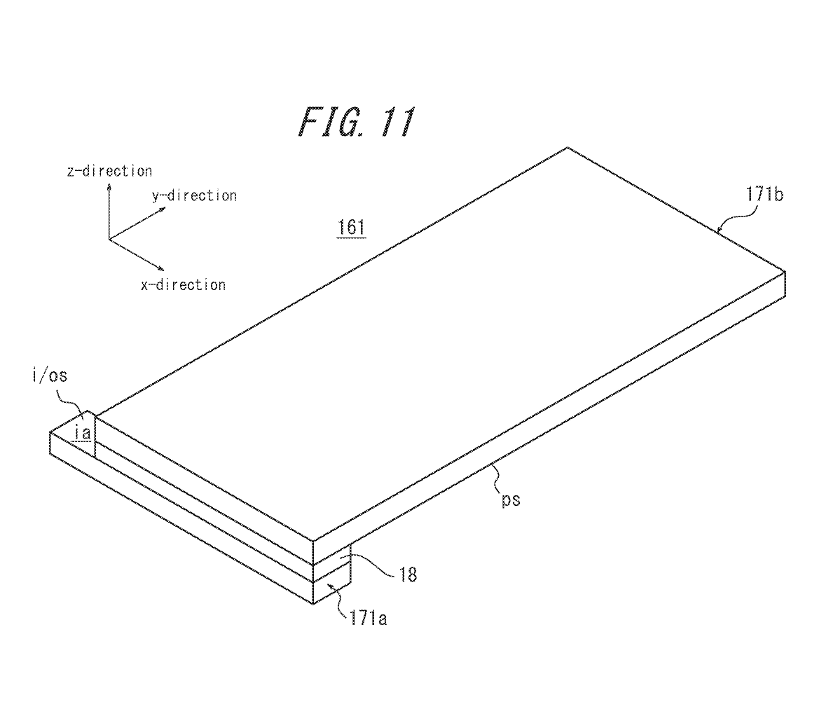

As illustrated in FIG. 11, like Embodiment 1, the λ/2 wavelength plate 18 is sandwiched between the first and second pupil enlarging plates 171a and 171b. Like Embodiment 1, the first and second pupil enlarging plates 171a and 171b are overlaid so that a long side of the first pupil enlarging plate 171a and a short side of the second pupil enlarging plate 171b overlap and so that the incident area ia of the first pupil enlarging plate 171a projects from the second pupil enlarging plate 171b. Unlike Embodiment 1, the first and second pupil enlarging plates 171a and 171b are overlaid so that the emission area ea (not illustrated in FIG. 11) of the input/output port surface i/os in the first pupil enlarging plate 171a and the incident area ia (not illustrated in FIG. 11) of the triangular prism array surface ps in the second pupil enlarging plate 171b face each other.

According to the optical mechanism 161 of Embodiment 3 with the above structure, there is no need to provide a constituent element such as the first pupil enlarging plate 171a at the surface that emits the pupil enlarged in two dimensions, i.e. at the side of the input/output port surface i/os of the second pupil enlarging plate 171b. Therefore, as explained below, the optical mechanism 161 is advantageous in terms of placement.

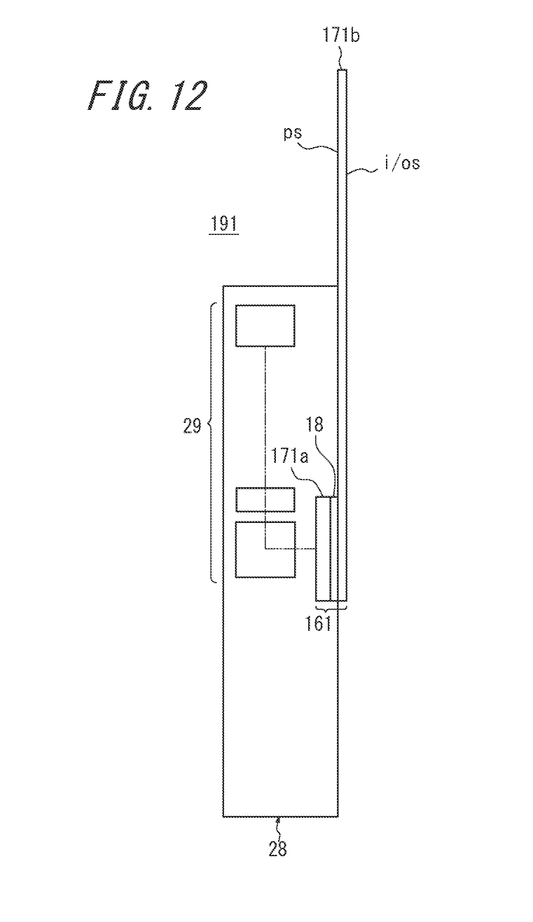

A display device using the optical mechanism 161 of Embodiment 3 is now described with reference to FIG. 12. A display device 191 includes a body 28 and the second pupil enlarging plate 171b. A projector optical system 29, the first pupil enlarging plate 171a, and the λ/2 wavelength plate 18 are provided within the body 28. The projector optical system 29 includes a light source (not illustrated), an illumination optical system (not illustrated), a transmissive chart (not illustrated), and a projection optical system (not illustrated). Accordingly, with the projector optical system 29, projection light from the chart is projected onto the optical mechanism 161.

The first pupil enlarging plate 171a and the λ/2 wavelength plate 18 are embedded in the body 28 with the λ/2 wavelength plate 18 exposed from the surface of the body. A support mechanism (not illustrated) is provided in the body 28. While keeping the triangular prism array surface ps of the second pupil enlarging plate 171b parallel to the surface of the body 28 where the λ/2 wavelength plate 18 is exposed, the support mechanism supports the second pupil enlarging plate 171b to be slidable in the length direction.

The support mechanism can lock the second pupil enlarging plate 171b at a position where the incident area ia of the second pupil enlarging plate 171b and the λ/2 wavelength plate 18 overlap. By causing the incident area ia of the second pupil enlarging plate 171b and the λ/2 wavelength plate 18 to overlap, the projected image of the chart can be emitted from the input/output port surface i/os of the second pupil enlarging plate 171b.

When adopting the optical mechanism 16 of Embodiments 1 and 2 in the above-described display device in which the display surface is slidable along the body, the first pupil enlarging plate 17a and the λ/2 wavelength plate 18 need to be provided on the display surface (the input/output port surface i/os of the second pupil enlarging plate 17b). In such a display device, however, it is not preferable to provide other elements on the display surface. By contrast, according to the optical mechanism 161 of Embodiment 3, the first pupil enlarging plate 171a and the λ/2 wavelength plate 18 are provided on the triangular prism array surface ps side of the second pupil enlarging plate 171b. Therefore, the entire surface of the optical mechanism 161 at the side of the second pupil enlarging plate 171b can be made planar. Accordingly, the optical mechanism 161 of Embodiment 3 is preferable for the above-described display device.

Furthermore, in a conventional display device in which the display surface is slidable along the body, electrical components are provided on the display surface and are connected to circuitry in the body and the like. When using the optical mechanism 161 of the present embodiment, however, electrical components need not be provided on the second pupil enlarging plate 171b, and connection wiring between the second pupil enlarging plate 171b and the body 28 is unnecessary. Since wiring is unnecessary, durability and water resistance can be enhanced as compared to a display panel using a conventional display device.

Next, an optical element according to Embodiment 4 of the present invention is described. In Embodiment 4, the thickness of the deflector differs from Embodiment 1. Embodiment 4 is described below focusing on the differences from Embodiment 1. Note that components with the same function and structure as in Embodiment 1 are labeled with the same reference signs.

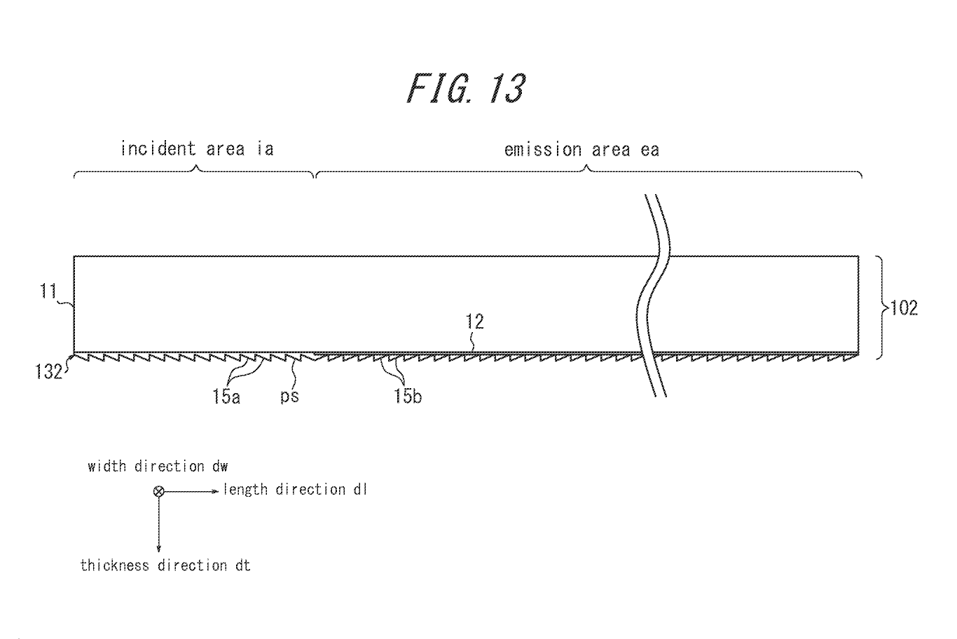

As illustrated in FIG. 13, an optical element 102 of Embodiment 4 includes a waveguide 11, a polarizing beam splitter film 12, and a deflector 132. The waveguide 11 and polarizing beam splitter film 12 have the same structure and function as in Embodiment 1.

Unlike Embodiment 1, the deflector 132 is only thick enough for formation of a triangular prism array surface ps. In other words, a plurality of first and second triangular prisms 15a and 15b are formed directly on the polarizing beam splitter film 12. For example, as in Embodiment 1, the polarizing beam splitter film 12 is formed on the waveguide 11, and after applying ultraviolet curable transparent resin to the film formation surface of the waveguide 11, the resin is irradiated with ultraviolet rays while a die is pressed thereagainst in order to harden the resin and form the first triangular prisms 15a and second triangular prisms 15b respectively below the incident area ia and the emission area ea.

According as well to the optical element of Embodiment 4 with the above structure, the incident light beam is expanded and emitted from only one plate surface of a flat plate. Therefore, while having a function to enlarge the pupil, the optical element offers improved use efficiency of light.

Furthermore, according to Embodiment 4, loss of light can be reduced. For example, when using the optical element 10 of Embodiment 1, a portion of the light beam Lx reflected by the first triangular prisms 15a may strike the polarizing beam splitter film 12 if the position of incidence of the light beam Lx is close to the emission area ea within the incident area ia. Accordingly, the amount of light entering the waveguide 11 might be reduced.

By contrast, according to the optical element 102 of Embodiment 4, the deflector 132 is thin, and therefore even if the light beam Lx strikes near the emission area ea within the incident area ia, the light beam Lx reflected by the first triangular prisms 15a is not likely to strike the polarizing beam splitter film 12. Therefore, loss of light can be reduced.

Note that the characteristic structure of Embodiment 4 as described above, i.e. the structure of the deflector 132, may be adopted in the optical elements 100 and 101 of Embodiments 2 and 3.

Next, an optical element according to Embodiment 5 of the present invention is described. In Embodiment 5, the structure of the polarizing beam splitter film differs from Embodiment 1. Embodiment 5 is described below focusing on the differences from Embodiment 1. Note that components with the same function and structure as in Embodiment 1 are labeled with the same reference signs.

Like Embodiment 1, an optical element of Embodiment 5 includes a waveguide 11, a polarizing beam splitter film 12, and a deflector 13. The waveguide 11 and deflector 13 have the same structure and function as in Embodiment 1.

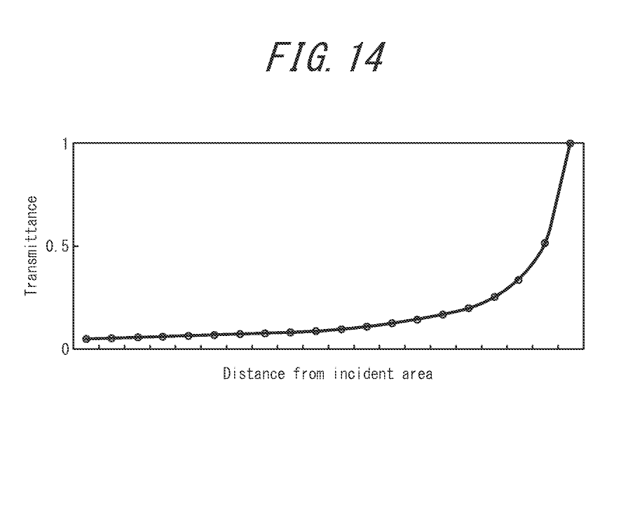

Unlike Embodiment 1, in Embodiment 5 the transmittance of the polarizing beam splitter film 12 with respect to obliquely incident light is not constant, but rather varies by position along the length direction dl. For example, the polarizing beam splitter film 12 is formed so that the transmittance increases as a geometric progression in accordance with distance from the edge of the polarizing beam splitter film 12 by the incident area ia (see FIG. 14). Note that the transmittance can be changed by position by, for example, overlaying the polarizing beam splitter film 12 with an ND filter that incrementally increases the transmittance.

According as well to the optical element of Embodiment 5 with the above structure, the incident light beam is expanded and emitted from only one plate surface of a flat plate. Therefore, while having a function to enlarge the pupil, the optical element offers improved use efficiency of light.

Furthermore, according to Embodiment 5, the use efficiency of light can be further improved while decreasing unevenness in the brightness. As described above, the use efficiency of light has a conflicting relationship with the unevenness in the brightness by eye position at the emission area ea side. In other words, uniformly lowering the transmittance reduces the unevenness in the brightness yet also reduces the use efficiency of light. Conversely, uniformly raising the transmittance increases the use efficiency of light yet also exacerbates the unevenness in the brightness.

By contrast, a structure such that the transmittance increases within the waveguide 11 with distance from the edge of the polarizing beam splitter film 12 at the incident area ia side, as in the present embodiment, allows for a decrease in the amount of light from the light beam Lx that reaches the edge of the waveguide 11 without being emitted while reducing the unevenness in the brightness. Accordingly, the use efficiency of light can be improved.

Note that the characteristic structure of Embodiment 5, i.e. the structure of the polarizing beam splitter film 12, may be adopted in Embodiments 1 through 4 as well.

Next, an optical element according to Embodiment 6 of the present invention is described. In Embodiment 6, the structure of the first and second triangular prisms differs from Embodiment 1. Embodiment 6 is described below focusing on the differences from Embodiment 1. Note that components with the same function and structure as in Embodiment 1 are labeled with the same reference signs.

Like Embodiment 1, an optical element of Embodiment 6 includes a waveguide 11, a polarizing beam splitter film 12, and a deflector 13. The waveguide 11 and polarizing beam splitter film 12 have the same structure and function as in Embodiment 1. The actual shape of the deflector 13 is the same as in Embodiment 1.

Unlike Embodiment 1, however, a triangular prism array surface of the deflector 13 is covered not with aluminum, but rather with a reflecting member having optical characteristics such that the reflecting member reflects light in a band that includes the wavelength of light incident on the incident area is as projection light and transmits light in the band of other visible light.

According as well to the optical element of Embodiment 6 with the above structure, the incident light beam is expanded and emitted from only one plate surface of a flat plate. Therefore, while having a function to enlarge the pupil, the optical element offers improved use efficiency of light.

Furthermore, according to Embodiment 6, since visible light outside of a predetermined band is transmitted by the first and second triangular prisms 15a and 15b, the image formed by the light beam Lx incident from the input/output port surface i/os side and the background behind the optical element 10 can both be observed.

Note that the characteristic structure of Embodiment 6, i.e. the structure of the first and second triangular prisms 15a and 15b, may be adopted in Embodiments 1 through 5 as well.

Although the present invention has been described based on the drawings and embodiments, it should be noted that various changes and modifications will be apparent to those skilled in the art based on the present disclosure. Therefore, such changes and modifications are to be understood as included within the scope of the present invention.

For example, in Embodiments 1 through 6, the pitch of the first through third triangular prisms 15a to 15c is exemplified as being 0.9 mm, yet the pitch is not limited to 0.9 mm. Furthermore, the pitch need not be consistent. For example, the effects of the above-described embodiments can be achieved even when mixing pitches of 0.8 mm, 0.9 mm, and 1.0 mm.

In Embodiments 1 through 6, the waveguides 11 and 111 are formed with quartz, yet alternatively a different material may be used. For example, heat-resistant glass such as PYLEX (registered trademark, Corning Incorporated), TEMPAX Float (registered trademark, Schott Aktiengesellschaft), Vycor (registered trademark, Corning Incorporated), or the like has a refractive index near that of quartz and is appropriate for formation of the waveguides 11 and 111.

In Embodiments 1 through 6, the inclination angle of the inclined surface in the first through third triangular prisms 15a to 15c is exemplified as being 25°, yet the inclination angle is not limited to 25°. As long as the majority or substantially all of the light obliquely incident from the input/output port surface i/os is reflected, and the reflected light is reflected by the second triangular prisms 15b in a direction substantially perpendicular to the input/output port surface i/os, then the inclination angle may be any angle.

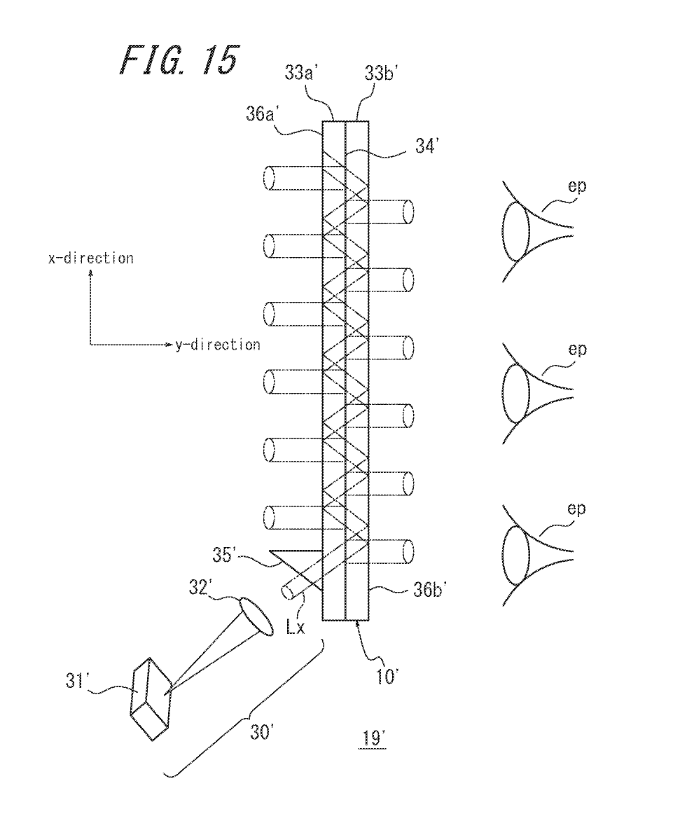

In Embodiments 1 through 6, the light beam Lx incident on the optical elements 10, 100, and 101 is reflected by the first triangular prisms 15a or the third triangular prisms 15c so as to enter the waveguide 11 or 111 obliquely, yet the light beam Lx may be caused to enter the waveguide 11 or 111 obliquely by a different method. For example, the triangular prism 35′ provided on the outer surface of the optical element 10′ in the known structure illustrated in FIG. 15 may be used to cause the light beam Lx to enter obliquely.

### REFERENCE SIGNS LIST

10, 100, 101, 10′: Optical element
11, 111: Waveguide
12: Polarizing beam splitter film
13, 131: Deflector
15a, 15b, 15c: First, second, third triangular prism
16: Optical mechanism
17a, 171a: First pupil enlarging plate
17b, 171b: Second pupil enlarging plate
18: λ/2 wavelength plate
19, 191: Display device
21: Transmissive chart
26: Polarizing highly reflective film
27: Cover glass
30′: Image projection unit
33′a, 33′b: First, second transparent medium
34′: Volume hologram sheet
35′: Triangular prism
ea: Emission area
ia: Incident area
i/os: Input/output port surface
Lx: Light beam
ms: Film formation surface
ps: Triangular prism array surface

1. An optical element comprising:
a first waveguide, formed as a plate having a first plane and a second plane opposing each other, that propagates light incident at a predetermined angle while reflecting the light between the first plane and the second plane;
a first beam splitter film, adhered to the first plane of the first waveguide, that separates light incident from the first waveguide into transmitted light and reflected light;
a first deflector, joined to the first waveguide with the first beam splitter film therebetween, having a plurality of first reflecting surfaces provided along a first direction, the first reflecting surfaces reflecting, in a direction substantially perpendicular to a surface of the first beam splitter film, light that is incident on the first plane at the predetermined angle and transmitted by the first beam splitter film; and
a plurality of second reflecting surfaces reflecting light incident on the optical element towards the first waveguide so that light is incident on the second plane at an angle of at least a critical angle in the first waveguide, the first beam splitter film reflecting a majority of light incident at the predetermined angle from the first waveguide and transmitting a majority or all of light incident in a substantially perpendicular direction from the first deflector, and
an angle between each of the first reflecting surfaces and the first plane being in a neighborhood of a half angle of the predetermined angle.

2. The optical element according to claim 1, wherein a transmittance of light obliquely incident on the first beam splitter film is uniform.

3. The optical element according to claim 1, wherein a transmittance of light obliquely incident on the first beam splitter film increases along the first direction.

4. The optical element according to claim 1, wherein the first deflector is formed thinly so that the first reflecting surfaces and the first beam splitter film intersect.

5. The optical element according to claim 1, wherein the first reflecting surfaces are covered by a reflecting member that reflects an entire band of visible light.

6. The optical element according to claim 1, wherein the first reflecting surfaces are covered by a reflecting member that reflects a band of visible light in a predetermined wavelength and transmits visible light outside of the predetermined band.

7. The optical element according to claim 1, wherein the first waveguide is formed from material having heat resistance.

8. The optical element according to claim 1, wherein the second reflecting surfaces are formed on a same surface as the second plane.

9. The optical element according to claim 1, wherein the second reflecting surfaces are formed in the first deflector.

10. The optical element according to claim 1, further comprising an oblique light reflective film, adhered to the second plane of the first waveguide, that reflects light obliquely incident from the first waveguide and transmits light incident in a substantially perpendicular direction from the first waveguide.

11. The optical element according to claim 10, further comprising a cover, formed from a light transmitting material, covering a side of the oblique light reflective film opposite the first waveguide.

12. An optical mechanism comprising:
the optical element according to claim 1 as a first optical element; and
a second optical element including:
a second waveguide, formed as a plate having a third plane and a fourth plane opposing each other, that propagates light incident at a second predetermined angle while reflecting the light between the third plane and the fourth plane;
a second beam splitter film, adhered to the third plane of the second waveguide, that separates light incident from the second waveguide into transmitted light and reflected light; and
a second deflector, joined to the second waveguide with the second beam splitter film therebetween, having a plurality of third reflecting surfaces provided along a second direction differing from the first direction, the third reflecting surfaces reflecting, in a direction substantially perpendicular to a surface of the second beam splitter film, light that is incident on the third plane at the second predetermined angle and transmitted by the second beam splitter film,
the second beam splitter film reflecting a majority of light incident at the second predetermined angle from the second waveguide and transmitting a majority or all of light incident in a substantially perpendicular direction from the second deflector, and
the first optical element and the second optical element being disposed so that light emitted from the fourth plane of the second optical element is incident on the second reflecting surfaces.

13. The optical mechanism according to claim 12, wherein a space is provided between the first optical element and the second optical element.

14. The optical mechanism according to claim 12, further comprising:
an oblique light reflective film, adhered to the fourth plane of the second waveguide, that reflects light obliquely incident from the second waveguide and transmits light incident in a substantially perpendicular direction from the second waveguide, wherein
the first optical element is disposed to adhere to the oblique light reflective film.

15. The optical mechanism according to claim 12, wherein
the second reflecting surfaces are formed on a same surface as the second plane, and
the first optical element and the second optical element are disposed so that the fourth plane faces the second reflecting surfaces with the first optical element therebetween.

16. The optical mechanism according to claim 12, wherein
the first optical element is supported to be displaceable in a direction parallel to the fourth plane of the second optical element, and
the light emitted from the fourth plane of the second optical element is incident on the second reflecting surfaces when the first optical element is displaced to a predetermined displacement position.

17. The optical mechanism according to claim 12, further comprising a Δλ/2 wavelength plate between the first optical element and the second optical element.

18. The optical mechanism according to claim 17, wherein
the first beam splitter film is a first polarizing beam splitter film, and
the second beam splitter film is a second polarizing beam splitter film.

19. The optical mechanism according to claim 12, further comprising a laser light source emitting laser light that is guided into the first optical element.

20. An optical mechanism comprising:
a first optical element;
a second optical element; and
a λ/2 wavelength plate between the first optical element and the second optical element,
the first optical element including:
a first waveguide, formed as a plate having a first plane and a second plane opposing each other, that propagates light incident at a predetermined angle while reflecting the light between the first plane and the second plane;
a first polarizing beam splitter film, adhered to the first plane of the first waveguide, that separates light incident from the first waveguide into transmitted light and reflected light; and
a first deflector, joined to the first waveguide with the first polarizing beam splitter film therebetween, having a plurality of first reflecting surfaces provided along a first direction, the first reflecting surfaces reflecting, in a direction substantially perpendicular to a surface of the first polarizing beam splitter film, light that is incident on the first plane at the predetermined angle and transmitted by the first polarizing beam splitter film,
the first polarizing beam splitter film reflecting a majority of light incident at the predetermined angle from the first waveguide and transmitting a majority or all of light incident in a substantially perpendicular direction from the first deflector,
the second optical element including:
a second waveguide, formed as a plate having a third plane and a fourth plane opposing each other, that propagates light incident at a second predetermined angle while reflecting the light between the third plane and the fourth plane;
a second polarizing beam splitter film, adhered to the third plane of the second waveguide, that separates light incident from the second waveguide into transmitted light and reflected light; and
a second deflector, joined to the second waveguide with the second polarizing beam splitter film therebetween, having a plurality of third reflecting surfaces provided along a second direction differing from the first direction, the third reflecting surfaces reflecting, in a direction substantially perpendicular to a surface of the second polarizing beam splitter film, light that is incident on the third plane at the second predetermined angle and transmitted by the second polarizing beam splitter film,
the second polarizing beam splitter film reflecting a majority of light incident at the second predetermined angle from the second waveguide and transmitting a majority or all of light incident in a substantially perpendicular direction from the second deflector, and
the first optical element and the second optical element being disposed so that light emitted from the fourth plane of the second optical element is incident on the first optical element.

21. An optical mechanism comprising:
an optical element; and
a laser light source emitting laser light that is guided into the optical element,
the optical element including:
a first waveguide, formed as a plate having a first plane and a second plane opposing each other, that propagates light incident at a predetermined angle while reflecting the light between the first plane and the second plane;
a first beam splitter film, adhered to the first plane of the first waveguide, that separates light incident from the first waveguide into transmitted light and reflected light; and
a first deflector, joined to the first waveguide with the first beam splitter film therebetween, having a plurality of first reflecting surfaces provided along a first direction, the first reflecting surfaces reflecting, in a direction substantially perpendicular to a surface of the first beam splitter film, light that is incident on the first plane at the predetermined angle and transmitted by the first beam splitter film,
the first beam splitter film being a polarizing beam splitter film that reflects a majority of s-polarized light incident at the predetermined angle from the first waveguide and transmits a majority or all of s-polarized light incident in a substantially perpendicular direction from the first deflector.
